(19) United States
(12) Patent Application Publication
(10) Pub. No.: US 2026/0010364 A1
(43) Pub. Date: Jan. 8, 2026

(54) SYSTEM AND METHOD FOR CLEAN BLOC ARCHITECTURE STATE MANAGEMENT

(71) Applicant: JIO PLATFORMS LIMITED, Ahmedabad, Gujarat (IN)

(72) Inventors: Aayush BHATNAGAR, Navi Mumbai, Maharashtra (IN); Pradeep Kumar BHATNAGAR, Navi Mumbai, Maharashtra (IN); Sundaresh SANKARAN, Mumbai, Maharashtra (IN); Haresh B AMBALIYA, Gujarat (IN); Nandakishor VALAKUNDE, Rupinagar, Maharashtra (IN); Yogeshwar BARGAL, Maharashtra (IN); Surya CHUNDAWAT, Salumber, Rajasthan (IN); Gunjan MALVIYA, Madhya Pradesh (IN)

(73) Assignee: JIO PLATFORMS LIMITED, Ahmedabad, Gujarat (IN)

(21) Appl. No.: 18/993,290

(22) PCT Filed: May 28, 2024
(86) PCT No.: PCT/IN2024/050622

§ 371 Date: Jan. 10, 2025

(30) Foreign Application Priority Data
Jun. 28, 2023 (IN) 202321043370

(51) Int. Cl. G06F 8/71; G06F 8/65

(52) U.S. Cl. CPC G06F 8/71; G06F 8/65

(57) ABSTRACT

The present disclosure provides a system and a method for clean bloc architecture state management. The system receives one or more inputs from one or more users. The one or more inputs are triggering events based on actions of one or more users. The triggering events are button clicks or form submissions. The system processes the triggering events to perform one or more logic operations for different use cases, maintains a current state of the application and produce updated states based on the received events and the current state. The new updated states are sent back for UI updates and the process repeats as the one or more users interacts with the application, triggering new events and resulting in updated states.

### RESERVATION OF RIGHTS

A portion of the disclosure of this patent document contains material, which is subject to intellectual property rights such as, but are not limited to, copyright, design, trademark, Integrated Circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF DISCLOSURE

The embodiments of the present disclosure generally relate to management of software applications. More particularly, the present disclosure relates to a system and a method for clean bloc architecture state management.

### BACKGROUND OF THE INVENTION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admission of the prior art.

In software development, state management refers to the management and manipulation of data that represents the current state of an application. This data can include user input, system settings, or any other relevant information necessary for the application to function correctly.

Traditionally, many applications have relied on approaches like setState to manage their state. The setState method is typically used in frameworks and libraries that provide a way to update component state, such as React's setState function. While this approach can work for simple applications, it can lead to several disadvantages as the complexity of the application grows.

One of the main drawbacks of using setState is that it often results in stateful components. Stateful components are those that manage their own internal state and handle state updates within themselves. This can lead to complex code that intertwines UI rendering and state management logic, making it harder to understand and maintain.

Another challenge with setState is that it can introduce unexpected side effects and make it difficult to reason about state changes. Asynchronous updates or complex dependencies can further complicate the management of state, leading to potential race conditions or inconsistencies in the application.

There is, therefore, a need in the art to provide a system and a method that can mitigate the problems associated with the prior arts.

### SUMMARY

In an exemplary embodiment, a system for performing architecture state management in a software architectural pattern that follows a bidirectional data flow is described. A user interface (UI) widget configured to receive a plurality of events corresponding to one of a plurality of applications performed by a user on the UI widget. The UI widget configured to display current state of the application. A business logic unit configured to receive the plurality of events corresponding to the application from the UI widget. In responsive to receiving the event from the UI widget, the business logic unit configured to perform a plurality of business logic operations for a plurality of use cases. The business logic unit configured to maintain the current state of the application. The business logic unit configured to produce an updated state based on the received events and the current state. The business logic unit configured to send the updated state of the application to the UI widget. The UI widget configured to reactively update the UI based on the updated state of the application and a repository configured to access and modify data from a plurality of data sources.

In some embodiment, the plurality of business logic operations comprises transforming events, managing application programming interface (API) requests, accessing a plurality of local databases, and performing data-related operations.

In some embodiment, the plurality of events comprises user interactions, button clicks, submission of forms.

In some embodiment, the plurality of data sources includes remote APIs, local databases, or external services.

In some embodiment, the repository configured to handle retrieval of data from the data sources, data storage, modification of data, encapsulating implementation details of the data sources.

In some embodiment, the repository configured to communicate with the business logic unit by sending data through callbacks, futures, and observables.

In another exemplary embodiment, a method for performing architecture state management in a software architectural pattern that follows a bidirectional data flow is described. The method comprises triggering, by a view layer, an event corresponding to one of the plurality of applications based on user interactions on a user interface (UI) widget of the view layer and displaying, by the UI widget, a current state of the application. The method comprises receiving, by a business layer, the event from the UI widget and in responsive to receiving the event from the UI widget, performing, by a business logic unit of the business layer, a plurality of business logic operations for a plurality of use cases. The method comprises maintaining, by the business logic unit, the current state of the application and producing, by the business logic unit, an updated state of the application based on the received event and the current state. The method comprises sending, by the business logic unit, the updated state of the application to the view layer and reactively updating, by the view layer, the UI based on the updated state of the application. The method further comprises accessing and modifying, by a repository, data from a plurality of data sources.

In some embodiment, the plurality of business logic operations comprises transforming events, managing application programming interface (API) requests, accessing a plurality of local databases, and performing data-related operations.

In some embodiment, the plurality of events comprises user interactions, button clicks, submission of forms.

In some embodiment, the plurality of data sources includes remote APIs, local databases, or external services.

In some embodiment, the repository configured to handle retrieval of data from the data sources, data storage, modification of data, encapsulating implementation details of the data sources.

In some embodiment, the repository configured to communicate with the business logic unit by sending data through callbacks, futures, and observables.

### OBJECTS OF THE INVENTION

Some of the objects of the present disclosure, which at least one embodiment herein satisfies are as listed herein below.

An object of the present disclosure is to provide a system and a method where clean bloc architecture separates the concerns of different layers in the application, such as the UI, business logic, and data layer.

An object of the present disclosure is to provide a system and a method where clean bloc architecture uses interfaces and abstractions to allow effective testing and reduce dependencies on external systems by making the application code more testable.

An object of the present disclosure is to provide a system and a method where clean bloc architecture assists in improvement of code maintainability with clear separation between layers and well-defined flow of data.

An object of the present disclosure is to provide a system and a method where clean bloc architecture abstracts implementation details behind interfaces to allow swapping of different implementations without affecting other layers.

An object of the present disclosure is to provide a system and a method where clean bloc architecture uses Bloc pattern and reactive programming with streams to enable reactive updates to the UI based on state changes.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an example network architecture (100) for implementing a proposed system (108), in accordance with an embodiment of the present disclosure.

FIG. 2 illustrates an example block diagram (200) of a proposed system (108), in accordance with an embodiment of the present disclosure.

FIG. 3 illustrates an example clean bloc architecture (300), in accordance with an embodiment of the present disclosure.

FIG. 4 illustrates a flow diagram (400) for the proposed clean bloc architecture state management, in accordance with an embodiment of the present disclosure.

FIG. 5 illustrates an example computer system (500) in which or with which the embodiments of the present disclosure may be implemented.

The foregoing shall be more apparent from the following more detailed description of the disclosure.

### DETAILED DESCRIPTION OF DISCLOSURE

In the following description, for explanation, various specific details are outlined in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items.

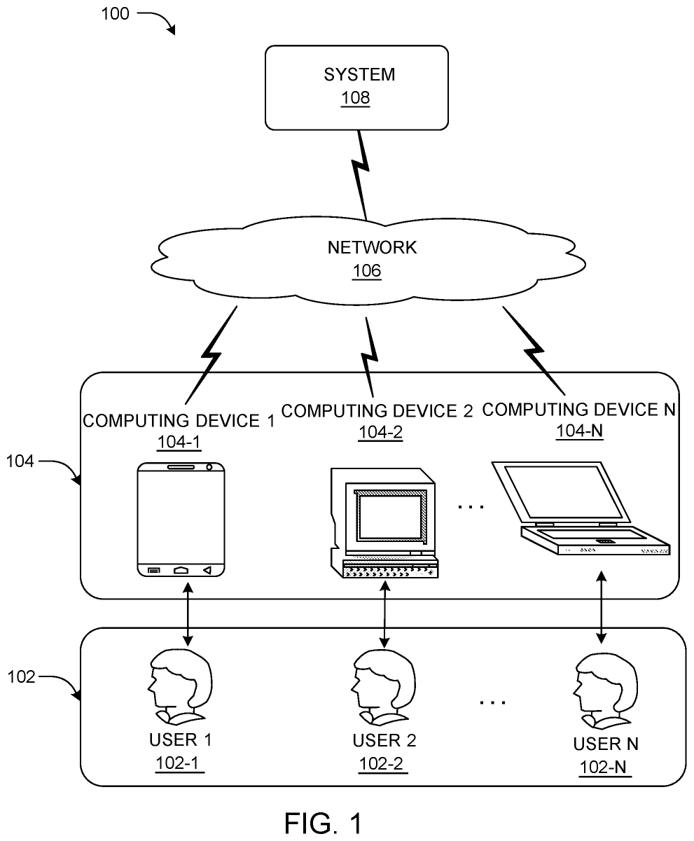

The various embodiments throughout the disclosure will be explained in more detail with reference to FIGS. 1-4.

As illustrated in FIG. 1, one or more computing devices (104-1, 104-2 . . . 104-N) may be connected to a proposed system (108) through a network (106). A person of ordinary skill in the art will understand that the one or more computing devices (104-1, 104-2 . . . 104-N) may be collectively referred as computing devices (104) and individually referred as a computing device (104). One or more users (102-1, 102-2 . . . 102-N) may provide one or more requests to the system (108). A person of ordinary skill in the art will understand that the one or more users (102-1, 102-2 . . . 102-N) may be collectively referred as users (102) and individually referred as a user (102). Further, the computing devices (104) may also be referred as a user equipment (UE) (104) or as UEs (104) throughout the disclosure.

In an embodiment, the computing device (104) may include, but not be limited to, a mobile, a laptop, etc. Further, the computing device (104) may include one or more in-built or externally coupled accessories including, but not limited to, a visual aid device such as a camera, audio aid, microphone, or keyboard. Furthermore, the computing device (104) may include a mobile phone, smartphone, virtual reality (VR) devices, augmented reality (AR) devices, a laptop, a general-purpose computer, a desktop, a personal digital assistant, a tablet computer, and a mainframe computer. Additionally, input devices for receiving input from the user (102) such as a touchpad, touch-enabled screen, electronic pen, and the like may be used.

In an embodiment, the network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network (106) may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

In an embodiment, the computing device (104) is communicatively coupled with a system (108). The system (108) may receive a connection request from the computing device (104). The system (108) may send an acknowledgment of the connection request to the computing device (104). The system (108) may receive one or more inputs from one or more computing devices (104) associated with the one or more users (102). The one or more inputs may be one or more triggering events based on actions of one or more users (102). The triggering events may be button clicks or form submissions. The system (108) can process the triggering events to perform one or more logic operations.

In an embodiment, the system (108) may produce new states based on the triggering events and the current state of the system.

In an embodiment, the system (108) may trigger new events and result in new update states based on the interaction of the one or more users (102) with the system (108).

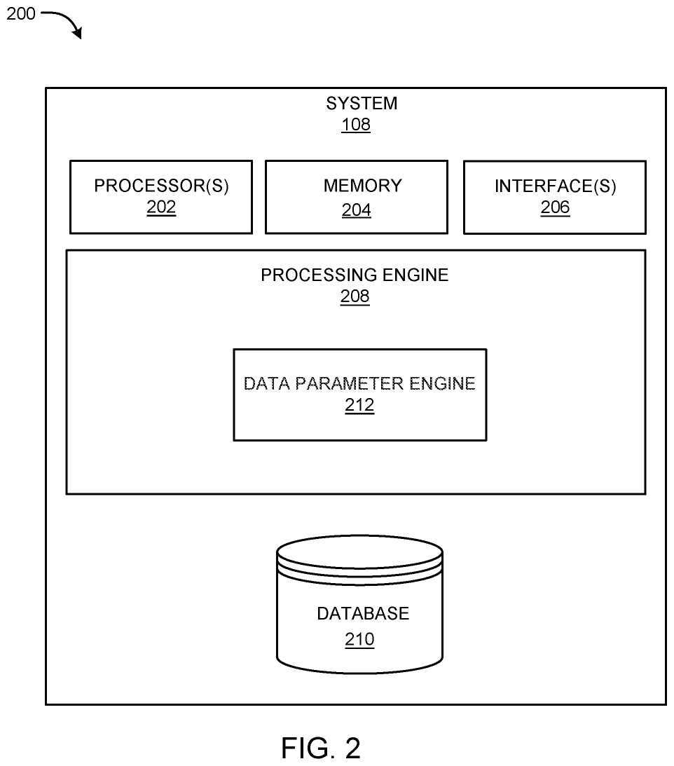

FIG. 2 illustrates an example block diagram (200) of a proposed system (108), in accordance with an embodiment of the present disclosure.

Referring to FIG. 2, in an embodiment, the system (108) may include one or more processor(s) (202). The one or more processor(s) (202) may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (108). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the system (108) may include an interface(s) (206). The interface(s) (206) may comprise a variety of interfaces, for example, interfaces for data input and output devices (I/O), storage devices, and the like. The interface(s) (206) may facilitate communication through the system (108). The interface(s) (206) may also provide a communication pathway for one or more components of the system (108). Examples of such components include, but are not limited to, processing engine(s) (208) and a database (210). Further, the processing engine(s) (208) may include a data parameter engine (212) and other engine(s). In an embodiment, the other engine(s) may include, but not limited to, a data ingestion engine, an input/output engine, and a notification engine.

In an embodiment, the processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system may comprise the machine-readable storage medium storing the instructions and the processing resource to execute the instructions, or the machine-readable storage medium may be separate but accessible to the system and the processing resource. In other examples, the processing engine(s) (208) may be implemented by electronic circuitry.

In an embodiment, the processor (202) may receive one or more inputs via the data parameter engine (212). The one or more inputs may be received from one or more computing devices (104) associated with the one or more users (102). The processor (202) may store the one or more inputs in the database (210). The one or more inputs may be one or more triggering events based on actions of one or more users (102). The triggering events may be button clicks or form submissions. The processor (202) can process the triggering events to perform one or more logic operations for different use cases.

In embodiment, the processor (202) may produce new states based on the triggering events and the current state of the system.

In an embodiment, the processor (202) may trigger new events and result in new update states based on the interaction of the one or more users (102) with the processor (202).

Although FIG. 2 shows exemplary components of the system (108), in other embodiments, the system (108) may include fewer components, different components, differently arranged components, or additional functional components than depicted in FIG. 2. Additionally, or alternatively, one or more components of the system (108) may perform functions described as being performed by one or more other components of the system (108).

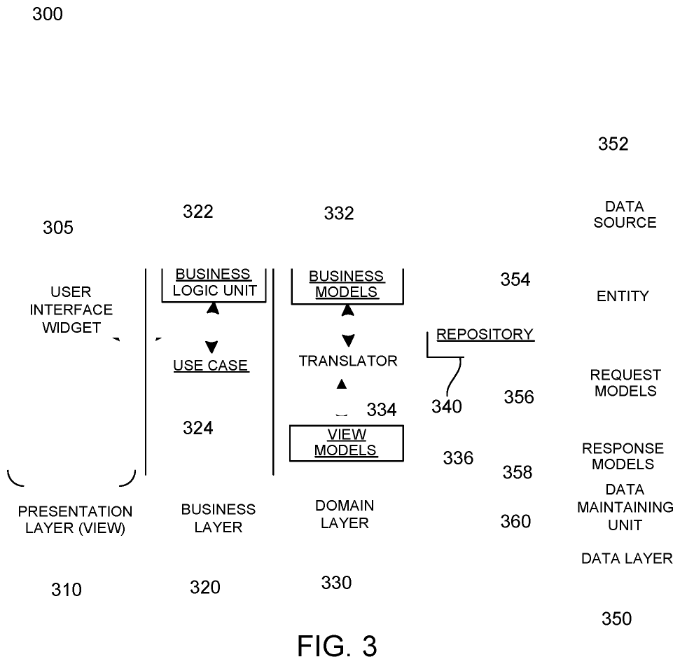

FIG. 3 illustrates an example clean bloc architecture (300), in accordance with an embodiment of the present disclosure.

As illustrated in FIG. 3, the following steps may be implemented by the system (108) for implementation of the proposed clean bloc architecture.

The clean bloc architecture follows a bidirectional data flow, separating the concerns of the user interface (view), a business logic (Bloc), and a data layer (repository). The clean bloc architecture may include a presentation layer (310), a business layer (320), a domain layer (330), a repository (340) and a data layer (350).

At the presentation layer (310) (for example, view layer): the presentation layer (310) may also be referred as a view layer. The view layer (310) may be responsible for displaying the current state of the application and handling the interactions of one or more users (102). The user interactions may comprise button clicks, form submission, etc. The view layer may trigger events based on the interactions of the one or more users (102). The view layer may communicate with the bloc layer by passing the trigger events to the bloc layer for processing and business logic operations for different use cases. The view layer may include stateless user interface (UI) widget (305).

The view (user interface UI stateless widgets) is responsible for rendering the user interface and transmitting user inputs to the application. The presentation layer (310) may act as an intermediary between the view layer and the business layer. The presentation layer (310) may handle user inputs, updates the view, and delegates business logic to the interactors.

At the business logic (Bloc) layer (320): The Bloc layer (320) may act as an intermediary between the view layer (310) and the data layer (350). The Bloc layer (320) may include a business logic unit (322) and use case (324). Further, the Bloc layer (320) may also be referred to as the business layer.

The business logic unit (322) represents the core data models and business objects of the application. The use cases may contain the application's business logic and use cases. The use cases (324) are responsible for coordinating data flow between the domain layer and the presentation layer.

The Bloc layer (320) may receive events from the view layer triggered by the interactions of the one or more users (102) and processing the events to perform business logic operations for different use-cases. The Bloc layer (320) may transform events, make API requests, access local databases and perform data-related operations through the repository layer (340). The data related operations may comprise a data ingestion, a real-time data processing, a quality management, transforming raw data into valuable insights, etc.

The Bloc layer (320) may maintain a current state of the application. The Bloc layer (320) may produce an updated states based on the received events and the current state of the application. The Bloc layer (320) may expose streams, observables and similar constructs that emit state updates.

At domain layer (330): the domain layer may include business models (332), translator (334), view models (334). The business models (332) contain the application's business data which is created by processing raw data received by the API. The translators (334) convert the data created in business models into view models. The view model (334) may bind the data exposed by the interactors to the UI components.

At Repository (340): the Repository (340) may abstract the data layer (350) from the bloc layer (320). The repository (340) may provide an interface for accessing and modifying data from different sources. The repository (340) may communicate with the bloc layer (320) by returning data through callbacks, futures, observables, and similar mechanisms and handle data retrieval, storage and modification.

At data layer (350): the data layer (350) may comprise a data maintaining unit (360). The data maintaining unit (360) may include a data source (352), entity (354), request models (356), response models (358).

The data sources (352) may be responsible for fetching and storing data from/to external sources. The sources comprise databases, network APIs, local storage, etc. The entity (354) is class which holds the raw data in the form of classes and objects. The request models (356) are skeletons which are required for requesting data from API. The response models (358) are skeletons which are required for fetching response data from API.

Further, the new updated states from the bloc layer may be sent back to the view layer for UI updates. The UI is updated according to the updated states received from the bloc layer. The process may repeat as the one or more users (102) interact with application, triggering new events and resulting in updated states.

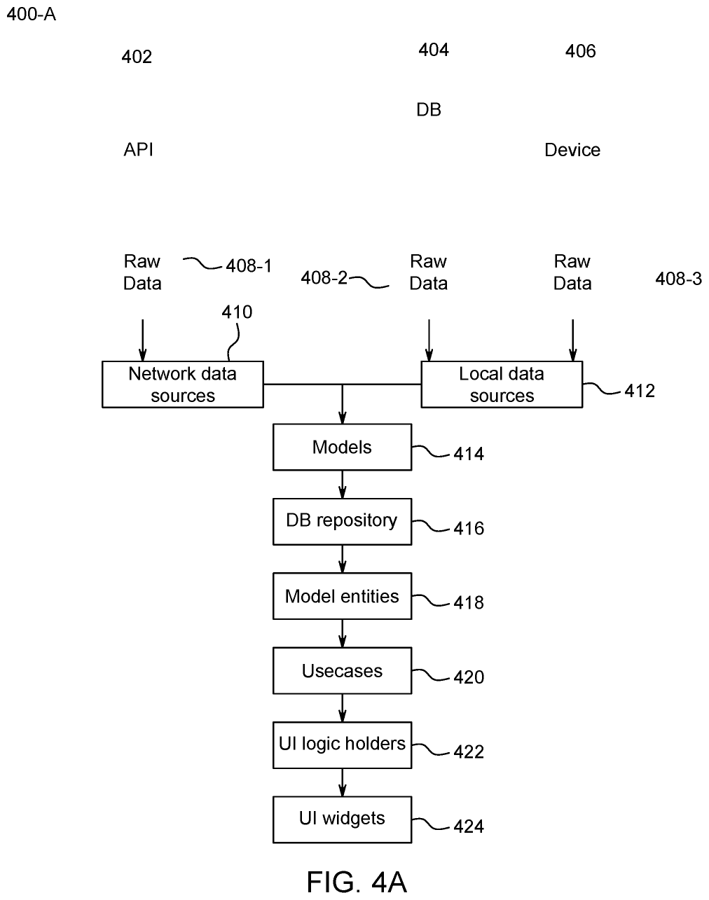

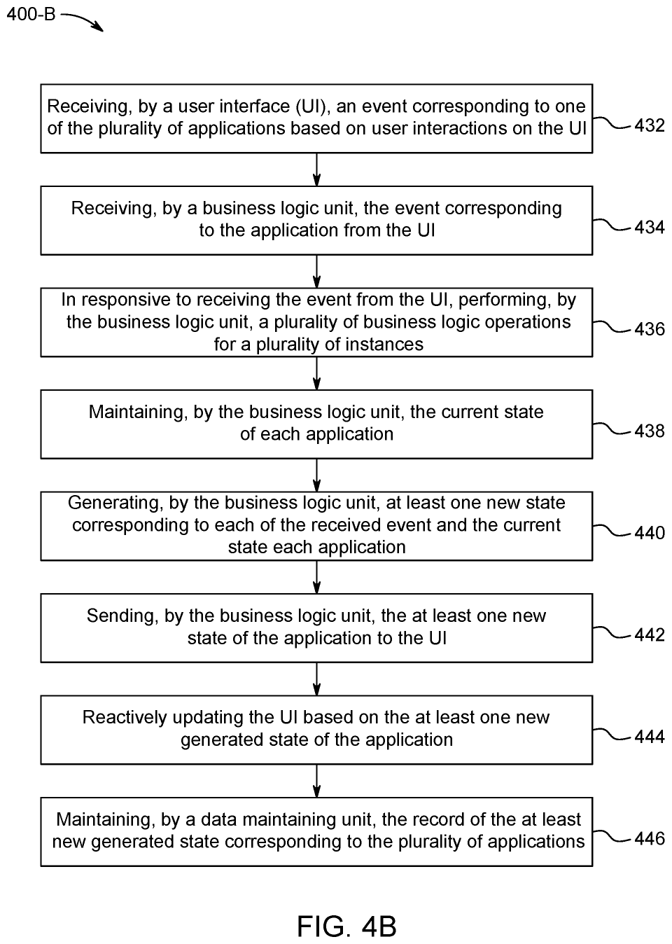

FIG. 4 illustrates a flow diagram (400) for the proposed clean bloc architecture state management, in accordance with an embodiment of the present disclosure.

At step 410, receiving raw data from plurality of data sources. The plurality of data sources may include application programming interface (API) (402), database (DB) (404), a device (406). The device (406) may be a computing device, a server, etc.

At step 420, raw data from the API (402) may send to network data sources.

At step 430, raw data from the database (404) and the device (406) may send local data sources (430).

At step 440, data from the network data sources and the local data sources may send to a plurality of models.

At step 450, data received from the network data sources and the local data sources data is processed by the models. The processed data may send to DB repository (340).

At step 460, the processed data from the DB repository (340) may send to plurality of model entities.

At step 470, data from the plurality of model entities may send to the plurality of use cases.

At step 480, data from the plurality use cases may send to UI logic holders. The UI logic may perform plurality of logical operations on the data.

At step 490, updating UI widgets according to the UI logic holders.

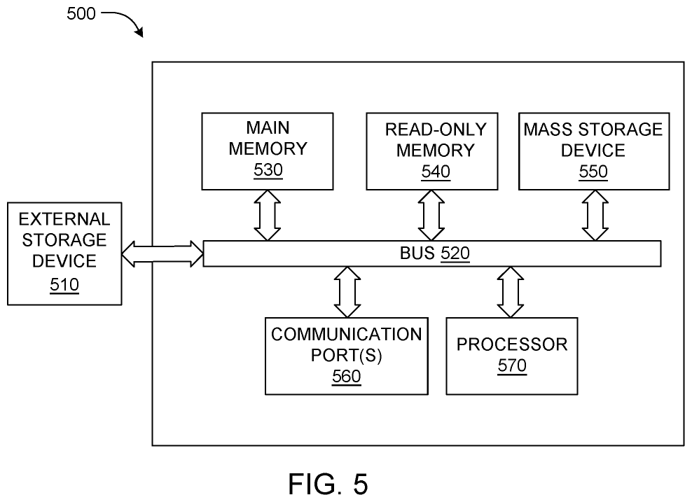

FIG. 5 illustrates an example computer system (500) in which or with which the embodiments of the present disclosure may be implemented.

As shown in FIG. 5, the computer system (500) may include an external storage device (510), a bus (520), a main memory (530), a read-only memory (540), a mass storage device (550), a communication port(s) (560), and a processor (570). A person skilled in the art will appreciate that the computer system (500) may include more than one processor and communication ports. The processor (570) may include various modules associated with embodiments of the present disclosure. The communication port(s) (560) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (560) may be chosen depending on a network, such as a Local Area Network (LAN), Wide Area Network (WAN), or any network to which the computer system (500) connects.

In an embodiment, the main memory (530) may be Random Access Memory (RAM), or any other dynamic storage device commonly known in the art. The read-only memory (540) may be any static storage device(s) e.g., but not limited to, a Programmable Read Only Memory (PROM) chip for storing static information e.g., start-up or basic input/output system (BIOS) instructions for the processor (570).

The mass storage device (550) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (520) may communicatively couple the processor(s) (570) with the other memory, storage, and communication blocks. The bus (520) may be, e.g. a Peripheral Component Interconnect PCI)/PCI Extended (PCI-X) bus, Small Computer System Interface (SCSI), Universal Serial Bus (USB), or the like, for connecting expansion cards, drives, and other subsystems as well as other buses, such a front side bus (FSB), which connects the processor (570) to the computer system (500).

In another embodiment, operator and administrative interfaces, e.g., a display, keyboard, and cursor control device may also be coupled to the bus (520) to support direct operator interaction with the computer system (500). Other operator and administrative interfaces can be provided through network connections connected through the communication port(s) (560). Components described above are meant only to exemplify various possibilities. In no way should the aforementioned exemplary computer system (500) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### Advantages of the Invention

The present disclosure provides a system and a method where clean bloc architecture promotes a clear separation of concerns by dividing the application into distinct layers which enhances code organization, making it easier to locate and modify specific components.

The present disclosure provides a system and a method where the changes in one layer of the clean bloc architecture have minimal impact on other layers, reducing the risk of introducing bugs and making code maintenance more manageable.

The present disclosure provides a system and a method where clean bloc architecture facilitates effective testing of the application and with the use of interfaces and dependency injection, dependencies can be easily mocked or replaced during testing, enabling comprehensive unit tests for each layer.

The present disclosure provides a system and a method where the clean bloc architecture follows a bidirectional data flow pattern, ensuring predictable state changes.

The present disclosure provides a system and a method where the components developed following the clean bloc architecture's principles can be easily reused in other projects or modules, reducing development effort and improving consistency.

1. A system for performing architecture state management in a software architectural pattern that follows a bidirectional data flow, the system comprising:
a user interface (UI) widget configured to receive a plurality of events corresponding to one of a plurality of applications performed by a user on the UI widget;
the UI widget configured to display a current state of the application;
a business logic unit configured to receive the plurality of events corresponding to the application from the UI widget;
in responsive to receiving the event from the UI widget, the business logic unit configured to perform a plurality of business logic operations for a plurality of use cases;
the business logic unit configured to maintain the current state of the application;
the business logic unit configured to produce an updated state based on the received events and the current state of the application;
the business logic unit configured to send the updated state of the application to the UI widget;
the UI widget configured to reactively update the UI based on the updated state of the application; and
a repository configured to access and modify data from a plurality of data sources.

2. The system as claimed in claim 1, wherein the plurality of business logic operations comprises transforming events, managing application programming interface (API) requests, accessing a plurality of local databases, and performing data-related operations.

3. The system as claimed in claim 1, wherein the plurality of events comprises user interactions, button clicks, and submission of forms.

4. The system as claimed in claim 1, wherein the plurality of data sources includes remote APIs, local databases, and external services.

5. The system as claimed in claim 1, wherein the repository is configured to handle retrieval of data from the data sources, data storage, modification of data, and encapsulating implementation details of the data sources.

6. The system as claimed in claim 1, wherein the repository is configured to communicate with the business logic unit by sending data through callbacks, futures, and observables.

7. A method for performing architecture state management in a software architectural pattern that follows a bidirectional data flow, the method comprising:
triggering, by a view layer, an event corresponding to one of the plurality of applications based on user interactions on a user interface (UI) widget of the view layer;
displaying, by the UI widget, a current state of the application;
receiving, by a business layer, the event from the UI widget;
in responsive to receiving the event from the UI widget, performing, by a business logic unit of the business layer, a plurality of business logic operations for a plurality of use cases;
maintaining, by the business logic unit, the current state of the application;
producing, by the business logic unit, an updated state of the application based on the received event and the current state of the application;
sending, by the business logic unit, the updated state of the application to the view layer;
reactively updating, by the view layer, the UI based on the updated state of the application; and
accessing and modifying, by a repository, data from a plurality of data sources.

8. The method as claimed in claim 7, wherein the plurality of business logic operations comprises transforming events, managing application programming interface (API) requests, accessing a plurality of local databases, and performing data-related operations.

9. The method as claimed in claim 7, wherein the plurality of events comprises user interactions, button clicks, and submission of forms.

10. The method as claimed in claim 7, wherein the plurality of data sources includes remote APIs, local databases, and external services.

11. The method as claimed in claim 7, wherein the repository is configured to handle retrieval of data from the data sources, data storage, modification of data, and encapsulating implementation details of the data sources.

12. The method as claimed in claim 7, wherein the repository is configured to communicate with the business logic by sending data through callbacks, futures, and observables.

13. (canceled)

14. A computer program product comprising a non-transitory computer-readable medium comprising instructions that, when executed by one or more processors, cause the one or more processors to perform a method for performing architecture state management in a software architectural pattern that follows a bidirectional data flow, the method comprising:
triggering, by a view layer, an event corresponding to one of the plurality of applications based on user interactions on a user interface (UI) widget of the view layer;
displaying, by the UI widget, a current state of the application;
receiving, by a business layer, the event from the UI widget;
in responsive to receiving the event from the UI widget, performing, by a business logic unit of the business layer, a plurality of business logic operations for a plurality of use cases;
maintaining, by the business logic unit, the current state of the application;
producing, by the business logic unit, an updated state of the application based on the received event and the current state of the application;
sending, by the business logic unit, the updated state of the application to the view layer;
reactively updating, by the view layer, the UI based on the updated state of the application; and
accessing and modifying, by a repository, data from a plurality of data sources.
